(19) United States
(12) Patent Application Publication
(10) Pub. No.: US 2002/0054205 A1
(43) Pub. Date: May 9, 2002

(54) Videoconferencing terminal

(76) Inventor: Henry S. Magnuski, Palo Alto, CA (US)

Correspondence Address: KAPLAN & GILMAN , L.L.P., 900NROUTE 9 NORTH, WOODBRIDGE, NJ, 07095, US

(21) Appl. No.: 09/790,854

(22) Filed: Feb. 22, 2001

Related U.S. Application Data
(60) Provisional application No. 60/183,916, filed on Feb. 22, 2000.

(51) Int. Cl. H04N 7/14

(52) U.S. Cl. 348/14.1

(57) ABSTRACT

A multicasting conferencing system is described wherein permanently or temporarily assigned addressing may be used. When permanently assigned multicast addressing is used, several channel parameters are assigned to a multicast session, and any terminals desiring to “tune in” to the multicast session simply invoke those parameters from a storage location at which they have been previously stored.

### RELATED APPLICATION

This application claims priority to Provisional Application No. 60/183,916, which was filed on Feb. 22, 2000 and to U.S. patent application Ser. No. ______, filed Feb. 20, 2001, both of which are incorporated herein by reference.

### TECHNICAL FIELD

This invention relates to videoconferencing, and more specifically, to an improved technique of implementing a multicast videoconferencing system.

### BACKGROUND OF THE INVENTION

Videoconferencing and streaming media systems for use over data networks are known in the art. A variety of techniques for implementing such a conference have been published and in use for at least a decade.

One “brute force” manner in which a videoconference may be implemented over a data network involves the broadcasting of packets in multiple copies to all other conferees. Specifically, each member of a videoconference that converts the information into the packets, may duplicate the packets and transmit them over to the data network, with each copy of the packet containing a separate one of the other conferee's addresses. In this manner, each packet produced is transmitted plural times, to different addresses.

An inefficiency with the foregoing is that much of the network bandwidth is wasted. The foregoing method does not take advantage of the fact that a single version of the packet could be sent partially through the network, where it may be split and sent to plural recipients. Additionally, processing power in each transmitting terminal is wasted, since each terminal must duplicate the same packet plural times.

A proposed solution to the foregoing system was developed during the 1990s by an Internet standards group and is termed “Multicast.” In multicast technology, a single copy of the packet traverses the data network until the last possible point where it may be replicated and still reach plural recipients. The packet is then replicated at that point. An example, with respect to FIG. 1, will help clarify. Consider a multicast packet originating at node 106 which is destined for both node 102 and 101. Multicast technology might employ a routing algorithm that routes the packet from 106 to 110, and from 110 to 108. However, the routing algorithm at node 108 would recognize the packet as a multicast packet, duplicate it, and transmit copies to each of nodes 101 and 102. Thus, while the packet must be replicated, it is transported as one packet for as long as possible until being copied to produce two or more packets.

It will be recognized by those of skill in the art that the above technique requires a specialized set of addresses to perform multicast conferencing. More specifically, it can be appreciated that the network 100 needs to be capable of routing packets in a conventional fashion from one node to the next when multicast packets are not at issue. Thus, with respect to conventional packet switching, each of the nodes in network 100 must be capable of examining a packet, performing a table lookup to determine the next node to which such packet should be routed, and sending the packet. With respect to multicast technology, each node must be capable of recognizing the address as a multicast address and duplicating the packet in a manner such that copies of the packet get routed to the next node on their way to various conference participants.

Further complicating the situation is the fact that the conference participants in any conference change on a dynamic basis. Thus, a particular multicast address may be utilized to identify a first conference at a first time, and a second conference at a second time. Each multicast address represents all of the conference participants and the nodes are programmed such that any packet with the multicast address is appropriately treated, duplicated where necessary, and sent to plural recipients.

Another problem with the foregoing is the fact that the multicast addresses are dynamic. More specifically, typically a band of addresses are reserved for multicast conferences. When a conference is desired to be started, the originator of the conference would randomly pick one of the band of addresses reserved for multicast. This band of addresses is referred to as Class D addresses.

To initiate the conference once the address is picked, a specialized software tool called a session directory (“SDR”) must announce to other network nodes that the session is to be on the particular random Class D address chosen. Users desirous of joining the conference must then attempt to configure in a manner to participate.

If a particular user's workstation is not turned on at the time that the announcement of the conference is made from the originating terminal's SDR, then the terminal, when later turned on, will have no information regarding the videoconference. Since the originating SDR would typically only repeat the conference information in 10-20 minute intervals, it could be a significant amount of time before a user knew what conferences were proceeding. Moreover, the entire process involves random dynamic addresses, software tools such as SDR, directories, and a variety of other complex software tools and files. In short, the system was complicated and cumbersome.

A slight improvement occurred in the late 1990s. A certain subset of the Class D addresses were declared to have special properties and were defined as being applicable in specified geographic areas. Since the specified geographic area may include, for example, a community of interest such as a particular corporation, or set of buildings, there is little chance of conflict among users competing for the same Class D addresses. Thus, it became possible to permanently assign certain administratively scoped addresses for specific multicast use.

The foregoing system does not take advantage of the full capability of such administratively scoped addresses. Additionally, prior videoconferencing systems lack effective ways of billing and managing the conferences.

In addition to the above, prior videoconferencing systems attempt to provide SVGA graphics image signals in conjunction with the video stream. However, this is usually done by providing a device separate from the conferencing terminal itself. While the use of a separate device avoids the problem of overloading the CPU and the computer bus with SVGA capture and processing, it increases the cost and complexity of the system.

Accordingly, there exists a need in the art for a technique of performing multicast which permits flexibility and ease of use in multicast systems, and specifically, in the use of administratively scoped multicast systems. There also exists a need in the art for an efficient way of billing and managing conferences, and of incorporating SVGA graphics images.

### SUMMARY OF THE INVENTION

The above and other problems of the prior art are overcome and a technical advance is achieved in accordance with the present invention. A multicast terminal is disclosed which may utilize prior art techniques of the type that reserve for conferences dynamic Class D addresses. However, the terminal also operates using certain specified permanent multicast addresses, and they are reserved for certain communities of interest. The permanent multicast address is defined as a permanent multicast channel, wherein each such channel includes a plurality of subchannels. Each subchannel may comprise a particular aspect of the channel. Thus, for example, a channel may include, in one simple example, three subchannels, one for audio, one for video, and one for graphics. Each channel comprises plural parameters, up to 63 in the exemplary embodiment, and some or all of the parameters may be subchannels.

Each of the channels may be referred to by name and may have a specific icon. Users can log on to particular multicast channels when desired, and a network administrator may change one or more parameters associated with the channel remotely.

In operation, the conferencing interface utilized by a terminal may load in conventional Class D channels or permanent multicast channels for operation. Thus, the terminal may interface with conventional Class D multicast systems, or with systems that utilize permanent multicast. In a preferred embodiment, some of the channels may include variable parameters, even though the channel itself is a permanently assigned multicast channel.

In an additional embodiment, a portion of memory internal to the videoconferencing terminal is utilized in conjunction with a Field Programmable Gate Array (FPGA) in order to digitize and process the SVGA signal without use of a separate device.

### BRIEF DESCRIPTION OF THE DRAWINGS

FIG. 1 shows a conceptual diagram of a data network architecture for use in implementing the present invention;

FIG. 2 depicts the basic steps of a flow chart that represents the operation of a terminal installed in a network and implementing an exemplary embodiment of the invention.

FIG. 3 depicts a functional block diagram of three components of a network node in accordance with the present invention; and

FIG. 4 represents an exemplary table for defining a “channel” as discussed with respect to the present invention.

### DETAILED DESCRIPTION OF THE PREFERRED EMBODIMENT

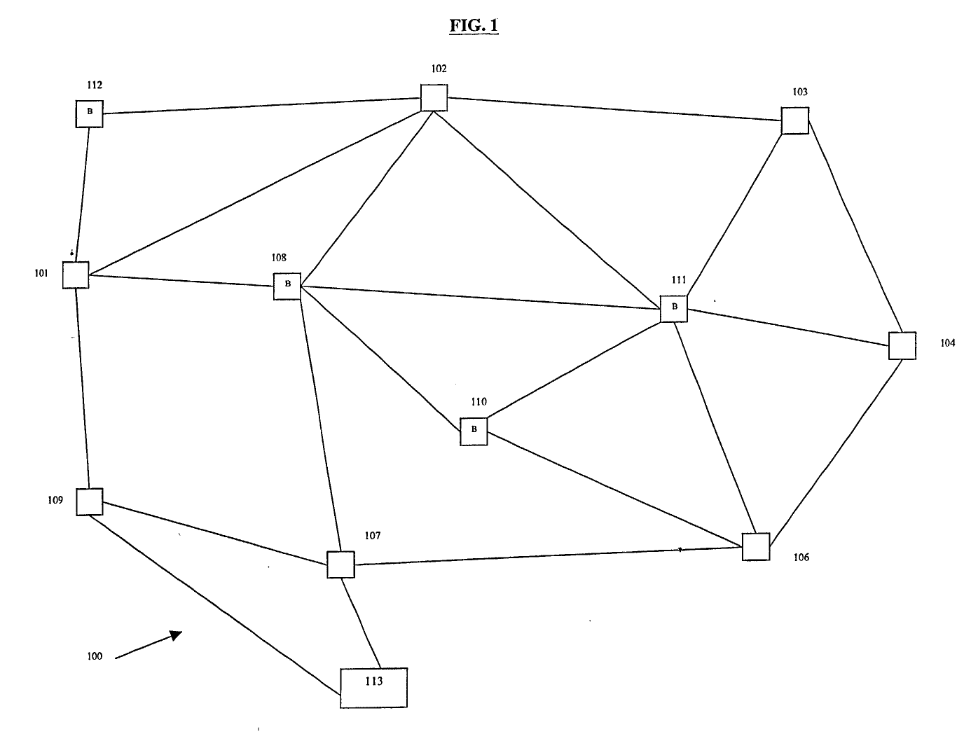

FIG. 1 depicts a plurality of nodes (e.g. terminals) interconnected together via a network 100. The network contains plural links connecting the nodes, and multicast conferences may be desired between any of the nodes.

Some of the nodes may require multicasting on a relatively permanent basis. For explanation purposes herein, we presume that in addition to general multicasting capabilities, nodes 104, 110, and 112 may be required to periodically and substantially permanently participate in multicast conferences. Such a need may arise for example, in a corporation where nodes 104, 110 and 112 represent the computer assigned to the members of the board of directors, and the multicast permanent addresses might be deemed “the board address”. One of the nodes of FIG. 1 may be a supervisory administrative node, which is designated as 113 in FIG. 1.

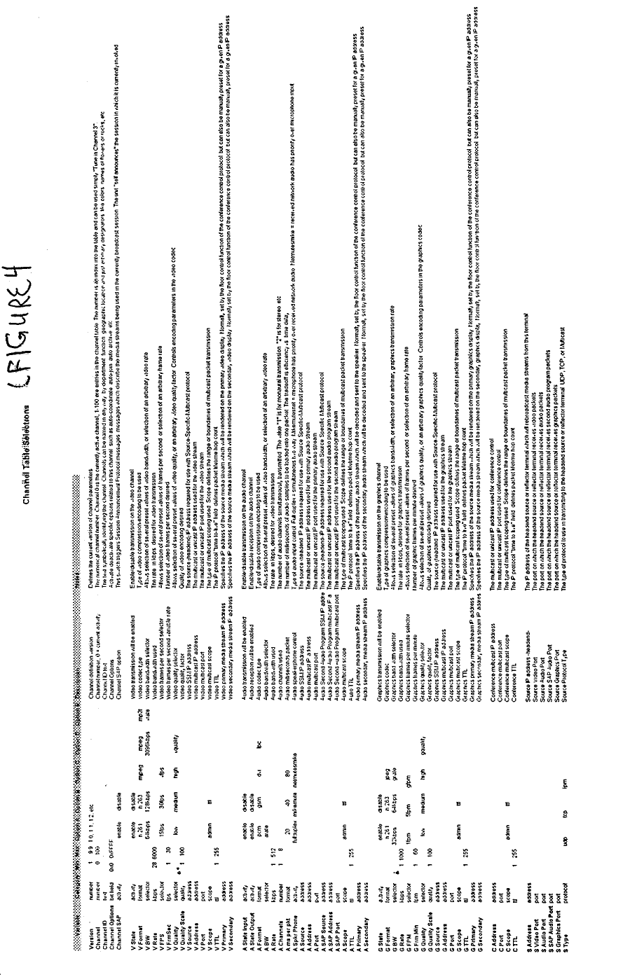

When it is desirable to assemble a group of users into a permanent multicast channel, the administrator-operating terminal 113 determines who the members of such channel should be. For explanation purposes, we assume that the administrator at terminal 113 determines that terminals 104, 110 and 112 should all be members of “the board channel”. In accordance with the present invention, the specific record designated as a permanent multicast channel definition record is transmitted from administrator 113 to terminals 104, 110 and 112. The record includes items such as the members of the conference, its name, particular designation, video and coding type and bandwidth, audio encoding type and bandwidth, graphics coding type, and other parameters. A definition of all of the parameters associated with a channel utilized in the prototype constructed of the present invention by the inventors hereof is included as FIG. 4 hereto.

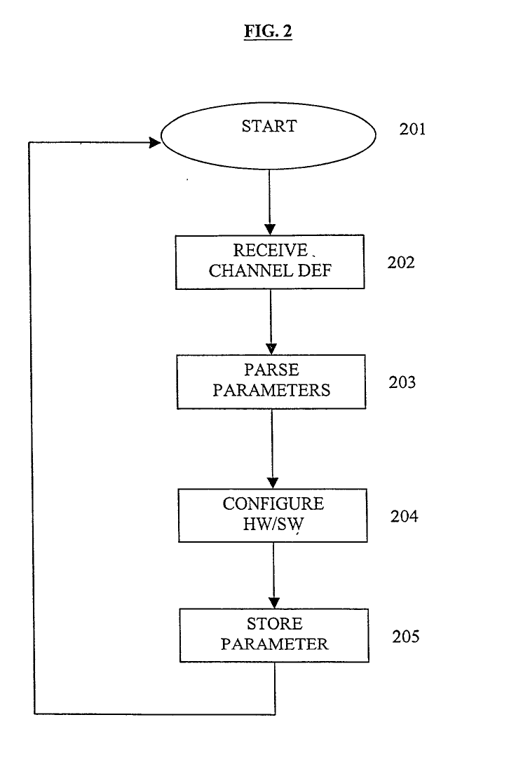

FIG. 2 shows a flowchart for implementation at an exemplary terminal 110 for receiving the channel definition record. In operation, the flowchart is entered at start block 201 and the channel definition is received at block 202. Upon receipt, the channel definition record is read into memory. In one exemplary embodiment, the exemplary node 111 may include the database of various definitions. In any event, the information required to define the channel, such as the 63 parameters set forth in FIG. 4 and utilized in the exemplary embodiment, are contained in the channel definition.

In an enhanced embodiment, some of the parameters may be fixed and assigned to the permanent multicast channel, and some may be variable. For example, the channel may have a particular parameter that determines whether a copy of the multicast conference is maintained at a server in the network. This may vary from session to session as the permanent multicast channels are used. Thus, the board of directors may have one multicast conference that they desire to be recorded, and another that they do not. Accordingly, the permanent channel database record may include a field indicative of whether or not the conference gets recorded, with a default value that the conference members may change from session to session. Nonetheless, at least a subset of the conference parameters are permanently assigned to the particular multicast record.

Continuing with FIG. 2, control is transferred to the parse parameters block 203 which reads the numerous fields within the permanent multicast channel record and determines what each of those fields means. The information conveyed is then utilized to determine how to configure hardware and software in order to participate in the particular multicast conference when invoked. Thus, for example, configure block 204 may determine that a specific encoding parameter requires that a specific signal processor be chosen from among several, or that a particular algorithm be utilized for encoding or encrypting the data. In short, configure block 204 translates the information in the permanent multicast channel record received from the administrator node 113 into specific utilization of resources at the receiving node 110. Those parameters are then stored by the receiving node 110 at block 205. The receiving node 110 is then able to participate in any such future permanent multicast conferences by simply invoking the parameters from the storage location utilized by block 205.

Notably, the parameters at block 205 need not be stored locally. More specifically, in the case of receiving terminal 110 being a “thin client” type of terminal, the terminal 110 may store a simple identifier which allows the actual parameters utilized for the permanent multicast conference to be retrieved from a remote server elsewhere in the network. Indeed, it is contemplated that the network could have one remote server which simply stores one large database of all of the permanent multicast parameters which the nodes simply retrieve when necessary.

In still a further embodiment, when a remote database as described above is utilized for storing permanent multicast conference parameters, it may be desirable to have each node store its own parameters in the remote database. This is because the same multicast channel definition record may result in different configuration parameters in each of several terminals.

The parameters listed in table 4 represent one full record associated with a particular permanent multicast channel. Each of the parameters may represent a subchannel so that a conference terminal desiring to enter a multicast conference taking place on the particular multicast channel would tune in to communicate on 63 different subchannels. Alternatively, the entire set of 63 exemplary parameters may be contained within several predefined subchannels that are associated with the permanent multicast conference. All of the information required to define the permanent multicast channel is contained in what is termed a permanent multicast channel definition records:

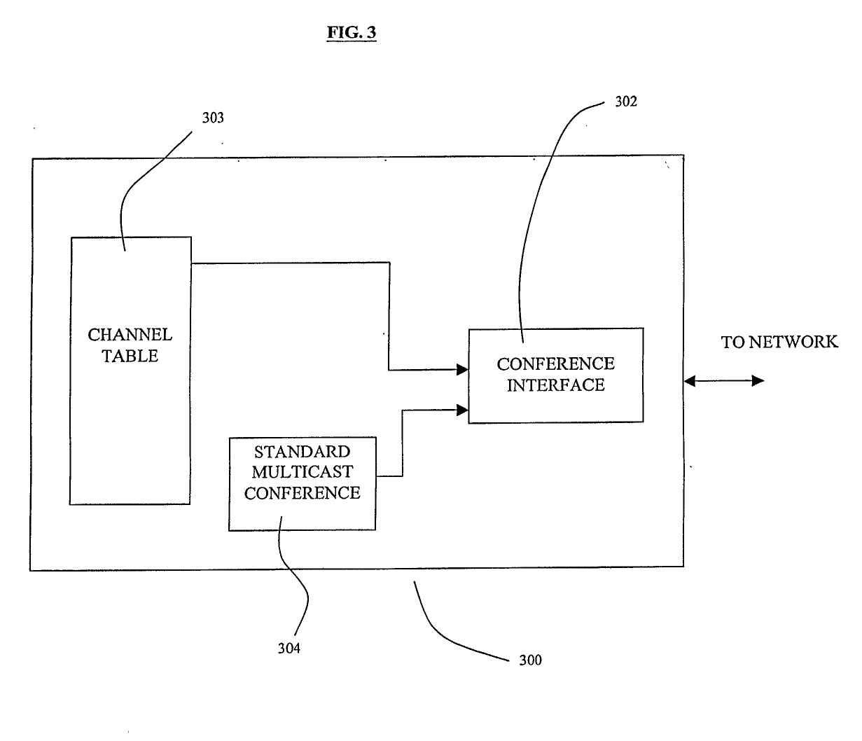

FIG. 3 shows three basic functional blocks of an exemplary node 111 required to participate in multicast conferences in accordance with an exemplary embodiment of the invention. Conferencing interface 302 is all of the image compression, encoding and decoding digital signal processing required to implement the videoconference. The specific type of such algorithms utilized is not critical to the present invention. The channel table 303 stores the parameters for using various permanent multicast channels, as the table is utilized by store parameter block 205 of FIG. 2. The channel table may include a plurality of permanent multicast channel definition records, each of which includes plural fields, some of which may be variable as discussed above.

The arrangement of FIG. 3 also includes a standard multicast conference block 304, which includes the algorithms for the Class D multicast addresses previously discussed. In accordance with the inventive technique, the conference interface may use standard SDR techniques to acquire the multicast conference parameters if the parameters are not stored in channel table 303.

When the user selects a particular conference, the terminal 300 will preferably first check the channel table 303 to determine if the desired conferences are part of the permanent multicast channel table 303. If so, the appropriate parameters are loaded into conferencing interface 302. If any such parameters are variable, then the specific values of such variable parameters may be received from an administrator, or may be exchanged with other conference members.

In still another embodiment, one of the subchannels associated with the permanent multicast channel may be reserved for the fixed parameters. Thus, if a permanent multicast channel includes the 63 exemplary parameters set forth in FIG. 4, such permanent multicast address may be included in only thirty subchannels, for example. Several of the thirty subchannels may include plural ones of the parameters set forth in FIG. 4, and other subchannels may only include one such parameter.

In accordance with the foregoing, a user's computer may contain plural “icons” that each represent a stored set of parameters from a permanent multicast address. By clicking on such an icon, a user can become a member of such a conference. The stored record that contains the parameters for the conference is loaded into memory, and the terminal is “tuned” for that conference. The selection of the icon on the part of the user causes two events to occur. First, the appropriate subchannels of the permanent multicast channel are loaded so that the terminal may participate in communications. Second, information on the subchannels is used to set appropriate parameters for the conference (e.g. encoding method).

With respect to the foregoing scenario, if the conference also includes variable parameters, the variable parameter portions of the stored record may not be adapted for the particular conference. Such parameters may be conveyed using a variety of techniques that can be implemented by an ordinarily skilled programmer. For example, the parameters may be requested from another member of the conference. Alternatively, the conference channel itself may be set up such that all variable parameters are on one of the subchannels. Thus, the conference channel actually comprises plural subchannels, one of which is immediately read when the user joins the conference in order to ascertain the values of the variable parameters.

Although the exemplary permanent multicast channel definition shown in FIG. 4 does not designate which parameters are permanent and which may vary, numerous ones of such parameters may be varied from session to session. For example, the “G state” variable may enable or disable the graphics channel, as described in FIG. 4. Although a particular graphics subchannel may be permanently assigned to a permanent multicast channel as that multicast channel graphics subchannel, the parameter “G state” may take on a different value from one session to another. Thus, a user joining a conference may immediately obtain the variable parameters by looking on a specific subchannel that defines the values of the variable parameters of that particular permanently assigned multicast channel.

The parameters to be specified with the permanent multicast channel may include the identity of the terminal given transmission rights to the exclusion of all others at a particular time, or may include any other information for arbitrating access among participants, including speaking order, order of video transmission, etc. For example, the permanent multicast record may include a definition of which video stream should be displayed at the video interface of each conference participant, or the maximum bandwidth permitted to be utilized by any media stream leaving a terminal of a conference participant. Such information may not only be prestored in the permanent multicast record, but may be dynamically changed at the time of the conference, or even during the conference, through the use of a control subchannel or via commands sent from a conference participant and entered via any convenient method such as icons, a web page, a remote control, etc.

The media stream accessed by a user may be toggled or switched between various subchannels. For example, a user may switch between video, data, or graphics to be displayed by utilizing a remote control that selects which subchannel is to be displayed. In still another embodiment, the commands to configure a terminal to join a conference may be sent from a remote computer terminal, server, or through a Web page. In one enhanced embodiment, a remote server is programmed to set up the conference by timing. For example, a remote server may invoke the conference at a specified time by transmitting the appropriate information to plural terminals in order to cause the plural terminals to configure themselves to use a particular channel at a particular time. In this manner, all of the conferences in the network may be controlled by a central administrative server, that simply sends out commands to various terminals at programmed times to invoke plural conferences as defined by an administrator. Alternatively, the “timed tuning” can be implemented locally at any one or more specific terminals.

In still another embodiment, users are provided with “smart cards” or other similar device that may hold identification and authorization information for one or more of the channels available. Such a technique provides a manner in which channels can be restricted, monitored, or even revenue generating. For example, each user may be given a smart card that they use with a card reader attached to a terminal. Upon swiping the card, a password may be required, after which channel authorization is given, the terminal invokes the appropriate parameters and subchannels, and allows the user to join a multicast conference on such channel. A record may be maintained that indicates the time spent on the conference, user number, etc. Such record is transmitted to a billing database, which may process the record and generate a bill in a manner determined by the designer of such a billing system.

Notably, the smart card itself may contain the parameters for the conference, which can then be utilized to supplement the stored table. Conferences may be joined by utilizing the parameters on the smart card, or by utilizing the parameters stored in the table. The table could be updated via use of the smart card. The multicast terminal may integrate the smart card reader for efficient administrative setup, user recognition, and billing tabulation. The Smart card reader will be a simple and easy to use device as the user needs only slide their card through the device in order to read their profile.

The use of a smart card reader with a smart card may be preferred when compared to other methods, such as web page active control since all the parameters for the user desired settings are stored on the user's specific smart card. If, for example, the user wanted MPEG-2 video to be transmitted with the name “Mark C” as the name of the videoconferencing terminal he need only save his settings to his smart card. This card can hold identification, authorization information, password protection, channel enablement and even a billing cycle.

Another solution the smart card reader poses is to solve the billing issues presented by systems of the type described herein. As the smart cards will carry identification of the user of the device, after the user swipes his card through to gain access to a particular channel a record could be maintained that indicates how much time a user spent on the conference, user number, etc. Such record could then be transmitted to a billing database, which may process the record and generate a bill in a manner determined by the designer of such a billing system.

Other possibilities for configuring any one or more terminals to join the conference may be implemented either in the terminals or elsewhere in the multicast communications system. For example, the terminal may include a simple remote controller, utilizing infra red technology similar to a television remote control, for moving between channels. Each terminal may have specified channel parameters loaded into its boot software, so that upon bootup, the terminal immediately goes to a specified default channel. Such a channel could be where important company messages are posted, so that each user would have such information as soon as they turn on their computer or other type of terminal.

In another embodiment, a channel coordinator is designated to issue control commands for the conference. The coordinator may be assigned as such upon boot up, and any other terminals that choose to select a channel that already has a coordinator assigned to it become participants in any conference taking place on that channel, subject to security controls and authentication. A conference coordinator may be employed in any of the described embodiments.

Certain channel parameters may be set and controlled from a Coordinator, a specified terminal or other device responsible for broadcasting various parameters, SDR announcements, and other items relevant to the conferences taking place. This allows a conference to be controlled by a coordinator. Any terminal providing broadcast announcements when joining the conference may include a delay means to ensure the user remains on the channel before providing the announcements. In this manner, random announcement due to “surfing” plural channels may be avoided.

A still further enhanced embodiment involves the use of a small section of memory within the videoconferencing terminal for storage of graphics image signals. Preferably, this memory is SRAM. The terminal is directly connected to a PC or similar device, as well as to the network. As standard video RGB signals representing graphics and intended to drive the monitor are captured by the conferencing terminal from a typical PC or similar device, they are stored in a memory separate from the main memory of the CPU. At times when the CPU and/or PCI bus activity is relatively low, the RGB samples are transferred to the CPU memory of the conferencing terminal in bursts of packets using DMA channels or a bus master mode. This method ensures that the large amount of data associated with the RGB samples does not significantly detract from the bus bandwidth available for other applications that the conferencing terminal is performing.

Once in main memory, the data is read by the CPU and compressed into a format suitable for transmission to the network, such as for example, JPEG, H.263 or H.261. Notably, the reading of the data out of main memory for transfer to and compression by the CPU may also occur during times when the CPU is relatively idle. This prevents the relatively large amount of processing required for the compression algorithm from detracting from CPU performance. Once compressed, the packets are then transmitted over the data network.

One particularly optimal method of performing the foregoing is to utilize the time during the “blanking” of the video signal to move, encode, and transmit the graphics information. Such blanking exists after each line of a standard RGB signal, and represents times of relatively low loading on the CPU and the bus of the conferencing terminal. This time can be utilized for processing of graphics signals.

A custom designed Field Programmable Gate Array (FPGA), which serves as the state machine, may be employed to generate the timing required to capture the RGB samples. Upon command from the host CPU the FPGA will generate all SRAM control signals to capture a single frame of digitized video. Following this, the PCI Bus Master Interface Controller will move data from the SRAM to main memory upon host command using a DMA or bus-master mode at the appropriate times.

In addition, an SVGA Encoder may also be employed. For example, in instances in which a large screen is needed for presentation materials, an SVGA monitor is too cumbersome and small to be adequate for this scenario. Therefore, an NTSC or PAL signal may be preferred to drive a television screen. In an exemplary embodiment, a MediaGX and associated Cx5530, and a Chrontel CH7003 digital PC to TV encoder is utilized to provide NTSC or PAL output in composite, S-video or SCART format as an extra output form. This encoder allows the graphical media stream received by the controller to be displayed on standard TV-style monitors, and solves the problem of not having enough SVGA monitors or a big enough monitor for presentation materials. The foregoing technique of SVGA encoding and transmission may be used in any terminal whether implementing the channel tables described herein or not.

Any of the foregoing techniques may be used in terminals with other ones of the techniques or separately. For example, the card reader and/or the video encoding aspects may be used in conjunction with, or exclusive of, the channel table aspect of the invention.

In more general embodiments, the media stream need not include video, but could instead include only one or more audio streams, or other media streams.

While the above describes the preferred embodiment, various modifications and/or additions will be apparent to those of ordinary skill in the art. Such modifications are intended to be covered by the following claims.

What is claimed is:

1. A multicast conferencing system comprising a plurality of terminals each including means for storing a plurality of subchannels associated with a multicast channel, and means for configuring said terminal to communicate on said subchannels when a user selects said multicast channel, wherein at least one of the subchannels is utilized to facilitate communications among users for a conference, and at least another of said channels is utilized to convey parameters to configure the channel to participate in the conference, at least one such terminal including a card reader to input said subchannels.

2. The system of claim 1 wherein each terminal comprises means for participating in multicast conferences that are set up by assigning a temporary set of one or more subchannels for the purpose of said multicast conference, and wherein each terminal also comprises means for participating in a permanent multicast conference.

3. The system of claim 2 wherein each permanent multicast address comprises plural subchannels, and wherein said subchannels comprise at least one for video, one for audio, and one for other data.

4. The system of claim 3 wherein each terminal comprises a memory and wherein said memory is arranged to store a graphics image for presentation along with said videoconference.

5. The system of claim 4 wherein said graphic image is of the SVGA format.

6. The system of claim 5 wherein storage and display of the graphic image is controlled by an FPGA.

7. A videoconferencing terminal for communicating over a data network comprising a table for storing a plurality of records, each record defining a channel, each record having plural fields, at least one field representing a video subchannel of said channel, at least one field representing and audio subchannel of said channel, and a media reading reader for inputting information into said records, and further comprising a means for joining a conference defined by information in said table or by information input directly from a storage media through said media reader.

8. The terminal of claim 7 wherein said media reader is a card reader.

9. The terminal of claim 8 further comprising a storage area configured to store graphics images to be displayed in addition to said videoconference, said storage area being connected to a means that reads out said graphics images during times that said terminal is idle.

10. A terminal for participating in multicast conferencing, said terminal comprising means for generating a plurality of icons on a screen, any one or more of which being selectable by a user, and means for storing parameters associated with a multicast conference to occur within parameters associated with said icon, said parameters including at least a first parameter to specify video communications, a second parameter to specify audio communications, a third parameter to specify graphics communications, and a fourth parameter to specify control communications for the multicast conference, said terminal also including a card reader for inputting said parameters, and software for displaying SVGA images stored in memory, said software including steps for monitoring processor activity and for processing SVGA images to be displayed during times of relatively low processor loading.

11. The terminal of claim 10 wherein at least some of said parameters are permanently associated with said icon, and wherein at one other one of said parameters varies for each particular conference set up.

12. The terminal of claim 11 wherein at least one icon is generated after parameters associated with a multicast conference are received from a remote destination.

13. A method of implementing a videoconference in a terminal comprising:
Transmitting a video subchannel of information to a network;
Capturing and processing a graphics subchannel of information during times when said video subchannel presents a relatively low load on said terminal.

14. The method of claim 13 wherein said times comprise a blanking period of said video signal.

15. The method of claim 13 wherein said processing comprises moving RGB signals from an external memory to a main memory.

16. The method of claim 13 wherein said processing comprises moving RGB signals from a main memory to a CPU, and converting said signals to a compressed format.

17. The method of claim 16 wherein the compressed format is one of either JPEG, H.241, or H.243.

18. The method of claim 16 wherein said compressed format signals are then transmitted onto a data network.
